(19) United States
(12) Patent Application Publication
(10) Pub. No.: US 2016/0002942 A1
(43) Pub. Date: Jan. 7, 2016

(54) Pump Controller

(71) Applicant: Paul Harvey Orlando, Katy, TX (US)

(72) Inventor: Paul Harvey Orlando, Katy, TX (US)

(21) Appl. No.: 14/793,736

(22) Filed: Jul. 7, 2015

Related U.S. Application Data
(60) Provisional application No. 62/021,476, filed on Jul. 7, 2014.

(51) Int. Cl. E04H 4/12; G05B 13/02

(52) U.S. Cl. CPC E04H 4/1245; G05B 13/021

(57) ABSTRACT

A pump controller and methods for adjusting a pump speed or pump run time based on one or more pump control data. The pump control data may include forecasted weather information and non-weather information. The pump controller can be controlled remotely.

### CROSS-REFERENCE TO RELATED APPLICATIONS

This application claims priority from U.S. Provisional Patent Application No 62/021,476, filed on Jul. 7, 2014, the content of which is incorporated herein by reference in its entirety.

### BACKGROUND OF INVENTION

The present invention relates to a controller for a pump. Pumps can be used to raise, transfer, compress and deliver fluids. Pool pumps can be used to re-circulate water from the pool through the pool's filtering system and then back to the pool. Chemicals are mixed with the pool water to sanitize it. The filter system can remove debris like algae and bugs. Thus, the pool pump and filter are important to maintain hygiene and pool water clarity.

### BRIEF DESCRIPTION OF THE DRAWINGS

FIG. 1 illustrates an exemplary system for controlling a pump in accordance with an embodiment.

FIG. 2 illustrates a method for optimizing the operation of a pump according to an embodiment

### DETAILED DESCRIPTION

Conventionally, a pool pump's electricity consumption is controlled by connecting the pump to a control device. The control device may control the water circulation through the pump so that the circulation is limited only to hours of the day when the pool is likely to be used. The most common pool pump control device is a mechanical timer. Typically, the consumer or user is required to manually adjust the run-time or pump speed based on weather conditions. Timers can also be calendar-based. The calendar-based timers run on historical data and set the pump speed and run-time by season or month. Due to the nature of changing weather patterns, Calendar based timers can only estimate pump functionality.

In order to optimize energy usage, the pool pump control device should operate a specified minimum run time based on current local temperature, ambient conditions and usage. However, current technologies either rely on annual historical data, current environmental conditions via sensors or require manual adjustment of runtime or speed, which allows less than optimal, over use or under use of the pump and peripheral equipment when historical data is not representative of actual data or the pool operator is not present to make adjustments. Conventional pump control devices are characterized by the limitation of lacking automatic adjustability based on current ambient weather conditions. Additionally, conventional pump control devices cannot be configured for future or forecasted weather conditions. Currently there are no products on the market that intelligently control the pool pump functions using relevant forecast data for the local environment. This forces the consumer/user/operator to investigate local temperature data and manually adjust run times daily, or to run the pump at what is the maximum run time needed every day resulting in a massive waste of energy.

Conventional pump control devices cannot be remotely controlled. They may also lack energy efficiency and they may not involve features to account for load shedding and other utility grid uses. Therefore, there is a need for a pump control device that can utilize energy efficiently and to overcome the limitations of the prior art/conventional pump control devices.

According to an embodiment, a computer-implemented method for controlling a pump, comprises: receiving data from one or more sources on a plurality of pump control parameters, wherein the pump control parameters comprises: forecasted weather conditions; and at least one non-weather parameter; generating an optimal state for the pump in dependence on the received data; and at predetermined intervals, upon determination that a pump state deviates from the optimal state by a predetermined threshold value, adjusting the pump state from a first state to a second state such that the second state substantially matches the optimal state for the pump, wherein the pump state comprises a pump speed and/or a pump run time. The pump can be a pool pump or a spa pump. In one embodiment, the pump is a fixed speed pump. In another embodiment, the pump is a variable speed pump. The data on forecasted weather conditions can be automatically received from a third part weather service. The data on forecasted weather conditions comprises data on local weather conditions. The data on forecasted weather conditions comprises data on at least one of wind, temperature, light, cloudiness, moisture, solar radiation, and pressure conditions. The data on the at least one non-weather parameter further comprises data on one or more characteristics of a pool. The data on the at least one non-weather parameter comprises data on a pool volume, a pool temperature, a water line pressure, a pump type, a pool filtration system, and input and output voltages supplied to the pump. The second state may involve an increased, decreased or paused pump speed and/or an increased, decreased or paused pump run time. The adjusting the state of the pump comprises energizing or de-energizing the pump at a predetermined time. The method further involves enabling a utility provider to automatically adjust the pump state and/or shutting down the pump such that a load on a power grid is reduced. The method can also include automatically adjusting the pump run time and/or automatically restarting the pump upon receiving an indication of a load shedding operation. The method may further involve shutting down the pump upon determining that the pump state exceeds a predetermined threshold value. The method further comprises raising an alarming indicator when the pump state exceeds the predetermined threshold value.

According to another embodiment, a pump controller comprises: a regulator for adjusting a state of a pump from a first state to a second state; and a processing unit in communication with the regulator, wherein the processing unit executes computer program code for: receiving data from one or more sources on a plurality of pump control parameters, wherein the pump control parameters comprises: forecasted weather conditions; and at least one non-weather parameter; generating an optimal state for the pump in dependence on the received data; and at predetermined intervals, upon determination that a pump state deviates from the optimal state by a predetermined threshold value, instructing the regulator to adjust the pump state from the first state to the second state such that the second state substantially matches the optimal state for the pump, wherein the pump state comprises a pump speed and/or a pump run time.

According to yet another embodiment, a non-transitory machine-readable storage medium comprises machine-implementable instructions for activities comprising: receiving data from one or more sources on a plurality of pump control parameters, wherein the pump control parameters comprises: forecasted weather conditions; and at least one non-weather parameter; generating an optimal state for the pump in dependence on the received data; and at predetermined intervals, upon determination that a pump state deviates from the optimal state by a predetermined threshold value, adjusting a state of the pump from a first state to a second state such that the second state substantially matches the optimal state for the pump, wherein the pump state comprises a pump speed and/or a pump run time.

The pump controller may be a “smart” device that controls the proper operation of a pool or spa pump. As used herein, the term “smart” includes an electronic device, generally connected to other devices or networks via different wireless protocols such as Bluetooth, NFC, WiFi, 3G, etc., that can operate to some extent interactively and autonomously. The pump controller can automatically adjust a pump state to a predetermined optimal value based on pump control data which includes data on weather conditions along with data on one or more non-weather parameters. As used herein, the term ‘state” refers to a run time and/or pump speed. The pump control data may be provided by a user/operator or it can be stored in a storage device, such as, a memory unit. The non-weather pump control data may include information on the pool volume, type of pool pump, geographical location of the pool, the type of chlorination system, type of filtration system, type of cleaning system, etc. The weather data includes forecasted or predicted weather information. However, the weather data may also include historical, real time ambient weather data. The term “weather” as used herein refers to atmospheric conditions with respect to wind, temperature, light, cloudiness, moisture, solar radiation, and pressure. As used herein, the term “forecast” means anticipated or future weather conditions. The weather data may be received through wireless or wired connectivity from the Internet and/or remote third party services. The weather data pertains to local weather conditions. The term “local weather” as used herein implies weather conditions in a geographical area that includes the pump and the pool to be cleaned. The geographical area may extend up to 100 miles.

The pump controller can be configured to include remote human interface functionality through a smart phone or a computer terminal to customize, alarm, and manually control the pump. The pump controller can allow consumers or utility providers to enable remote load shedding to reduce the load of the power grid, as and when needed, by adjusting the pump run time to off-peak times.

The pump controller can reduce waste of electrical energy consumption of the pool pump and can enable better maintenance of the pool by accurately controlling water flow, chemical treatment, and filtration. The pump controller can maintain accurate record or time keeping. The pump controller can be configured to allow remote monitoring, alarm, and remote control for user/operator convenience. Advantageously, the pump controller firmware (or software programmed in read only memory) can be automatically updated.

The pump controller can be remotely monitored and controlled. Therefore, a user can manage a remotely located pump controller although the pump and the pump controller may be located in a different geographic location from the user. Through the real-time adjustment of a unique set of predetermined pump control parameters, the pump controller can be configured to substantially reduce electrical energy consumption. Thus, the pump controller can conserve energy. This allows the user to save money on utility expenses while going “green”.

The pump controller can also enable a user, for example, a commercial utility provider or a residential consumer, to optimize the run time of the pump run time and/or the speed of the pump. The run time of the pump is the time the pump should be run (for example, X hours) in order to turn over the total volume of water in the pool at least once per day.

The pump controller can be configured to automatically facilitate load shedding in order to reduce the load on the power grid. Pumps operate on electrical power. Typically, the pump users rely completely or at least in part on the public power grid. The public power grid is designed to provide electrical power or energy at any needed time. In general, load shedding involves determining the amount of load that has to be reduced or removed from operation immediately to keep the remaining portions of the power grid operational. The pump controller can be configured to shed load by turning off the pump at any particular time in response to modifiable, preset criteria. Additionally, the pump controller can be configured to operate at pre-designated off peak hours when electric rates are typically lower. The pump controller can be configured to utilize pump operational data to monitor, repair, maintain or replace the pump or its components, and to facilitate a regular maintenance and record keeping program.

As will be appreciated by one skilled in the art, one or more embodiments of the pump controller, as disclosed herein, may be a system, a computer-implemented method or a computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in one or more computer readable medium(s) having computer readable program code embodied thereon.

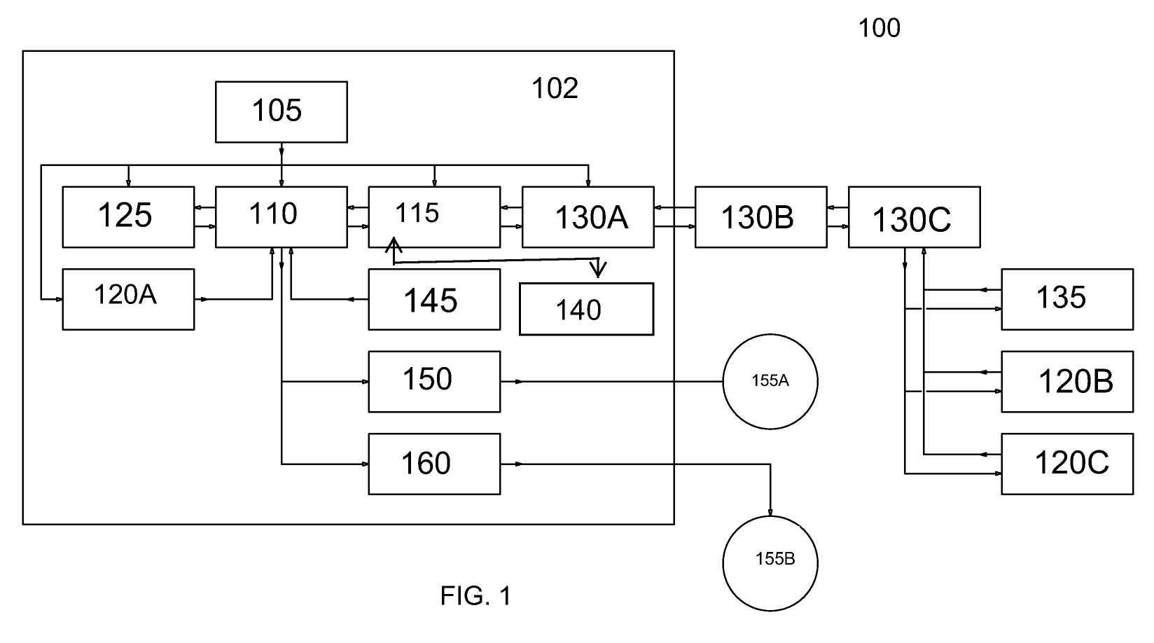

FIG. 1 is a block diagram of a pump controller 100 in accordance with an exemplary embodiment. The pump controller 100 can automatically/dynamically control any pool or spa pump known in the art in order to reduce energy consumption and to keep the pool clean. The pump may be single speed pump or a two/multiple speed pump 155A or a variable speed pump 155B (generally referred to as “pump(s) 155”). The pump controller 100 can control a desired functionality or pump state, such as, the speed and/or run time of the pump 155. The pump speed and run time can be controlled remotely. The term “remotely” implies control by a user who is not in an immediate proximity to the pump 155. One or more components of the pump controller 100 may be installed on or in close proximity to the pumps 155.

The pump controller 100 can include a housing 102. The housing 102 may include a plurality of components, such as, a regulator 110, a display control unit 125, an input/output unit 120A, a processing unit 115, sensors 145, a digital output relay 150, an analog output 160 and a communication network 130. In one embodiment, in lieu of the housing, the pump controller 100 can include a system board or a mother board 102 for mounting the plurality of components.

The pump controller 100 may be configured to control a pump, for example, a fixed speed pump 155A or a variable speed pump 155B. The pump controller 100 can include one or more devices 145 for monitoring the pump and measuring predetermined characteristics. The monitoring and measuring devices 145 may include one or more sensors, such as, local sensors. The sensors 145 may monitor and measure information pertaining to moisture, temperature, light, heat indices, input and output voltages. The sensors 145 may include a pressure sensor to monitor pool pressure, a chemical sensor to determine if and when chemicals are to be introduced the pool, a water level sensor for determining water level in the pool, a safety sensor, or a pool entry sensor.

The pump controller 100 may further include a digital output relay 150 and an analog output relay 160. The digital output relay 150 may be in operative communication with the fixed speed pump 155A. The digital output relay 150 may energize or de-energize the fixed speed pump 155A to start or stop the fixed speed pump 155A based on instructions received from the processing unit. 115 The analog output 160 may be in operative communication with the variable speed pump 155B. The analog output 160 may be configured to increase or decrease the speed of the variable speed pump 155B based on instructions received from the processing unit 115. These relays 150, 160 are normally open. The relays 150, 160 can close sending electricity to the pump 155 which can start the pump 155 at a predetermined time every day.

The regulator 110 can be configured to continually and dynamically monitor or determine a current state of the pump 155 based on input received from the processing unit 115 and the sensor 145. For instance, the regulator 110 can determine a current speed and run time of the pump 155 in real time. The determined state of the pump 155 can be identified as a first state.

If the first state is determined to be sub-optimal, the regulator 110 can change the state of the pump 155 to a desired or optimal second state. The change can be made automatically and can be made in nearly real time. For instance, the regulator 110 can increase or decrease the speed of the pump 155 from a current or determined speed or it can pause the operation of the pump 155 during run time. The regulator 110 can also increase or decrease the run time of the pump 155 from a current run time in order to improve the efficiency of operation of the pump 155.

The regulator 110 can receive power from power supply unit 105. The power supply unit 105 may receive a constant voltage from an external power source, etc., divide the voltage into various levels of voltages, and supply those voltages to the regulator 110, the processing unit 115, and the display control unit 125, etc.

The regulator 110 can be operatively coupled to the processing unit 115. The processing unit 115 may receive the voltage from the power supply unit 105 to control the regulator 110 and the display control unit 125. The processing unit 115 may be provided with a microprocessor. The processing unit 115 may include logic circuitry that responds to and processes instructions for software that may be loaded into a memory unit 140. The processing unit 115 may be a number of processors, a multi-processor core, or some other type of processor, depending on the particular implementation.

The memory unit 140 is an example of a storage device. A storage device is any piece of hardware that is capable of storing information, such as, for example, without limitation, data, namely, pump control data, program code, and/or other suitable information either on a temporary basis and/or a permanent basis. Memory unit 140 may be, for example, a dynamic random access memory, a read only memory (ROM) or any other suitable volatile or non-volatile storage device. The memory unit 140 may be a hard drive, a floppy drive, a thumb drive, a flash drive, an optical storage such as a compact disc (CD) or a digital video disc (DVD), a rewritable magnetic tape, or some combination of the above. The media used by the memory unit 140 also may be removable. For example, a removable hard drive may be used for the memory unit 140.

Instructions for the processing unit 115, applications, and/or programs may be located in memory unit 140, which is in communication with processing unit 115 for execution by the processing unit 115. The processes of the different embodiments may be performed by the processing unit 115 using computer-implemented instructions, which may be located in the memory unit 140. These instructions are referred to as program instructions, program code, computer usable program code, or computer readable program code that may be read and executed by the processing unit 115. The program code in the different embodiments may be embodied on different physical or computer readable storage media, such as the memory unit 140.

Program code may be located in a functional form on computer readable media that is selectively removable and may be loaded onto or transferred to the pump controller 100 for execution by processing unit 115. Program code and computer readable storage media form computer program product in these examples. In these examples, computer readable storage media is a physical or tangible storage device used to store program code rather than a medium that propagates or transmits program code. Computer readable storage media is also referred to as a computer readable tangible storage device or a computer readable physical storage device. In other words, computer readable storage media is a media that can be touched by a person. Alternatively, program code may be transferred to the pump controller 100 using computer readable signal media. Computer readable signal media may be, for example, a propagated data signal containing program code. For example, computer readable signal media may be an electromagnetic signal, an optical signal, and/or any other suitable type of signal. These signals may be transmitted over the network 130 or other communications links, such as wireless communications links, optical fiber cable, coaxial cable, a wire, and/or any other suitable type of communications link. In other words, the communications link and/or the connection may be physical or wireless in the illustrative examples.

In some embodiments, program code may be downloaded over the network to memory unit 140 from another device or data processing system (not shown) through computer readable signal media for use within the pump controller 100. The data processing system providing program code may be a server computer, a client computer, or some other device capable of storing and transmitting program code.

The program code includes algorithms or processes for automatically/dynamically adjusting a pump state based on pump control data. The pump control data includes input required by the computer code to adjust the pump state. The memory unit 140 can include pump control data for ensuring optimal and energy efficient pump operation. The pump control data may include information received from sensors 145. The pump control data may include information provided by a user. For example, the pump control data can include information regarding one or more unique characteristics of the pool and the pump, such as, the pool volume or capacity, pool temperature, water line pressure, type and number of pool pumps, geographic location of the pool, the chemicals (for example, a chlorination system) used to treat the pool water, the type of filtration system, the type of cleaning system, date, month, energy use limits, alarm limits, location (address/zip code/latitude or longitude), heat and light indices, and input and output voltages, and other relevant information. The pump control data may further include data for various weather conditions. For example, the pump control data may include information regarding historical, real-time and forecasted (for example, a seven day forecasted) weather and temperature conditions. The pump control data may also include historical, real-time and forecasted ambient light (for example, ultraviolet or UV light) conditions. Advantageously, the weather and light ambient condition data may include real time and forecasted weather and light data. Real time and forecasted weather and light ambient condition data may be received through a wireless device or through wired connectivity using networks 130A, 130B and 130C. The real time weather and light ambient condition data may be received from the Internet and/or remote servers that include this information through physical or wireless communication networks. Based on all input data, an optimal pump state can be calculated either remotely or automatically locally by the pump controller.

The networks 130A, 130B, 130C (generally referred to as network(s) 130) can be the same type of network or different types of networks. The network 130 can be private or public networks. The network 130 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 130 may comprise a wireless link, such as an infrared channel or satellite band. The topology of the network 130 may be a bus, star, or ring network topology. The network 130 and network topology may be of any such network or network topology as known to those ordinarily skilled in the art capable of supporting the operations described herein.

The processor 115 may utilize the network 130 to upload and download pump control data into and from memory 140 and input/output units 120. The pumps 155 may be controlled remotely through input/output units 120A, 120B, 120C. Input/output units 120A, 120B, 120C (generally referred to as input/output unit(s) 120) allow for input of pump control data. The input/output units 120 can interface with other devices that may be connected to the pump controller 100. For example, input/output units 120A, 120B may provide a connection for user input through a keyboard, touch screen keypad, a mouse, and/or some other suitable input device while input/output unit 120C may include a computer or a smart phone or any handheld unit or mobile device. Further, input/output unit 120 may display output at a display control unit 125. The display control unit 125 can include a mechanism to display information to a user. The display control unit 125 may include, without limitation, any output device such as, a computer screen, a touch screen display, a printer, a plotter, a magnetic tape, a removable hard disk, a floppy disk, etc.

The different components illustrated for the pump controller 100 are not meant to provide architectural limitations to the manner in which different embodiments may be implemented. The different advantageous embodiments may be implemented in a pump controller including components in addition to or in place of those illustrated for the pump controller 100. Other components shown in FIG. 1 can be varied from the illustrative examples shown. The different embodiments may be implemented using any hardware device or system capable of running program code.

For example, the processing unit 115 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code may be omitted, because the processes for the different embodiments are implemented in a hardware unit.

In another example, a bus system may be used to implement a communications fabric and may be comprised of one or more buses, such as a system bus or an input/output bus. The bus system may be implemented using any suitable type of architecture that provides for a transfer of data between different components or devices attached to the bus system. Additionally, network 130 may include a number of devices that transmit data, receive data, or transmit and receive data, for example, a modem or a network adapter, two network adapters, or some combination thereof.

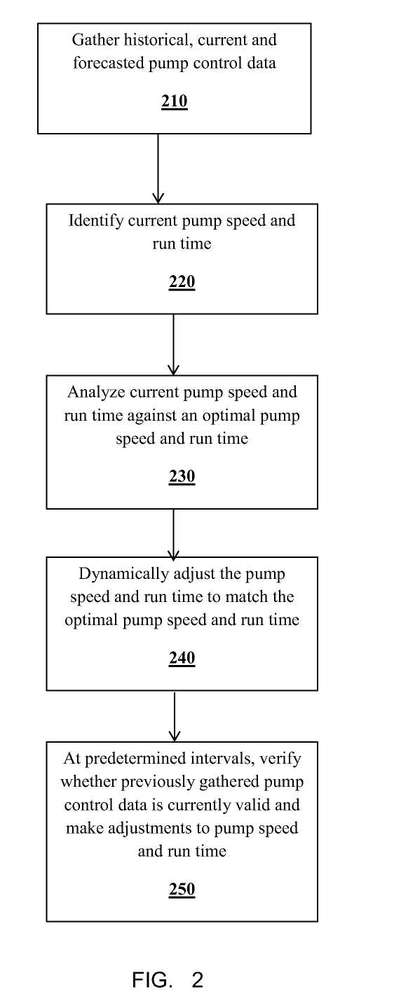

FIG. 2 illustrates a method for optimizing the operation of a pump according to an embodiment. The method involves collecting predetermined pump control data 210. Pump control data may include weather data, such as, forecasted local weather data, and other non-weather data relevant to maintaining a clean and healthy pool. The non-weather data may relate to the unique characteristics of a particular pool (for example, pool volume, etc.). The non-weather data may be provided by a user/operator using one or more input/output devices. The non-weather data can also be conveniently stored a storage device and retrieved when required. The weather data may be obtained from one or more remote services that include this information. For example, weather data may be obtained from a third party web service, such as, Accuweather.com®. However, the weather data may be automatically obtained from any source, for example, a local, state or national weather service, and can also be provided by the user. The method further involves identifying the current state, such as, the speed and run time of the pump 220. The current state of the pump is analyzed against an optimal pump speed and run time 230. The optimal pump speed and run time can be predetermined based on the weather and non-weather pump control data. In response to the analysis, the pump speed and run time can be dynamically adjusted such that the adjusted pump speed and run time substantially match the optimal pump speed and run time 240. At predetermined intervals, the pump control data is collected again and compared to the data gathered in step 210. If the previously gathered pump control data is still valid, that is, it substantially matches or is within a predetermined threshold of the newly collected pump control data, no further adjustments are made to the pump speed or run time. However, if the previously gathered pump control data is found to be not valid, that is, it does not substantially match or if it is outside a predetermined threshold of the newly collected pump control data, the pump speed or run time are adjusted such that the pump can continue to operate optimally 250.

According to another embodiment, a method for remote energy management by a utility or energy company is disclosed. The utility company can be given limited, permission-based access to the pump controller disclosed herein. The utility company can access the pump controller using a remote network protocol to reduce the energy usage of the corresponding pool. The utility company can remotely reduce system load by selectively shutting down the pool pump during periods of relatively high ambient temperature. Alternately, the utility providers can reduce forecasted or anticipated system load by ensuring that the pump controller can shut down the pool pump during the anticipated peak load time. The pump controller can be configured to restart during an off-peak time. According to another embodiment, the pump controller can be configured to receive an indication (such as, a signal or an alarm) that indicates a high system load. In response to the indication, the pump controller can be configured to trigger an automatic shutdown of the pool pump.

According to an embodiment, the pump controller can control a pump by retrieving predetermined pump control data periodically or continually to ensure that the data is retrieved in substantially real-time. The predetermined pump control data may be data that has been previously identified as relevant to the local environment. When the pump controller detects a change in the retrieved pump control data, for example, when it detects a change in the local temperature, the digital output relays and the analog output for speed control can adjust the pump state to match the changed data. Therefore, the pump controller can be adapted to be adjusted on a substantially real time basis to changing conditions and demands. Accordingly, the pump controller can facilitate an intelligent control of the functionality of the pump.

Utility companies/providers may be given permission-based access to the pump controller through any connectivity method known in the art in order to reduce energy usage of the pump. If the pump controller, is interrupted by load shedding requirements, or if the pump controller is required to be placed in a manual stop/run operation, the runtime can be corrected to meet a desired optimal run time.

According to yet another embodiment, if any sensor, for example, the safety sensor (which may include, a ground fault sensor, a pump pressure differential sensor, or a pool entry sensor—when outside of allowable time) reaches a safety limit, the pump can be shut down. An alarm may be sent to a designated user or users. The alarm may include an email, text message or may include sounds or other visual displays.

According to another embodiment, the pump controller may have a human interface. For instance, the pump controller may include local or remote control of the pump. The operator or user may select the pump controller to be placed in one of a “HAND”, “OFF” or “AUTO” setting. The operator can also set the pump controller for a manual run time or a manual “off” time.

In another embodiment, an initial set-up method for the pump controller is disclosed. The method includes providing user access to the pump controller for controlling the pump functionality, as described earlier. The pump controller may employ security procedures to prevent unauthorized users from accessing, obtaining, or altering pump control data. Such access control mechanisms may employ known authentication techniques to allow users to prove their identity and if authorized to do so, gain access to input/output units for controlling one or more pumps. In one embodiment, each pump may be associated with the user such that only one or more authorized users can adjust or control the pump.

In one embodiment, the user can log onto a secure website or an application (“app”) on a smart phone. The user can set up the pump controller to connect to a local area network or they can plug the system in a network cable. The user may enter pump control data for a selected location. The user can be allowed to opt out or to set up for electrical load shedding with a local energy/utility provider. The pump control data may be stored in the memory. The pump control data may be used locally to configure the system for optimal operation. As described earlier, the memory can be configured to retrieve pump control data on periodic or continual basis to adjust pump functionality based on the retrieved pump control data.

The pump controller may be conveniently integrated with other pool devices. The pump controller can be configured to provide reminders/alarms, and to notify the user to change a filter via a pressure sensor or to add chemicals via chemical sensors. The user may be notified when the water levels fall below a threshold level using a low water level sensor. Additionally, the pump controller can enable freeze prevention based on forecasted weather data

The pump controller can be used by any homeowner with a pool. The pump controller can be utilized by professional pool maintenance companies and other private pool owners (hotels, gyms, apartment complexes etc.).

In yet another embodiment, a non-transitory computer program product for controlling a pump state to enable efficient operation of the pump is disclosed. The computer program product comprises a computer readable storage medium having program instructions embodied therewith. The program instructions are executable by a computing device to perform a method, in accordance, with one or more embodiments described earlier. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein, the words “comprise,” “have,” “include,” and all grammatical variations thereof are each intended to have an open, non-limiting meaning that does not exclude additional elements or steps. Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. For instance, handheld units may be used as input devices in lieu of a remote computer or a smart phone. Although the one or more embodiments are referred to with reference to a pump for a pool or a spa, the pump can be any device that can be used to regulate a fluid flow. Also, the embodiments of the present invention are independent the type of pump, input and output voltages, language, source of ambient weather condition information, etc. Furthermore, persons skilled in the art may adapt the teachings of the present invention to control other pool or pool pump devices. For example, the embodiments of the present invention can be used by a water control device to access current and forecasted weather/temperature data in order to optimally irrigate a lawn or garden. All such adaptations are considered to be within the scope of the present invention.

Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention. While the pump controller and methods for controlling the pump are described in terms of “comprising,” “containing,” or “including” various components or steps, the battery and methods also can “consist essentially of” or “consist of” the various components and steps. Also, the terms in the claims have their plain, ordinary meaning unless otherwise explicitly and clearly defined by the patentee. Moreover, the indefinite articles “a” or “an”, as used herein, are defined to mean one or more than one of the element that it introduces. If there is any conflict in the usages of a word or term in this specification and one or more patent(s) or other documents that may be incorporated herein by reference, the definitions that are consistent with this specification should be adopted.

1. A computer-implemented method for controlling a pump, comprising:
receiving data from one or more sources on a plurality of pump control parameters, wherein the pump control parameters comprises:
(1) forecasted weather conditions; and
(2) at least one non-weather parameter;
generating an optimal state for the pump in dependence on the received data; and
at predetermined intervals, upon determination that a pump state deviates from the optimal state by a predetermined threshold value, adjusting the pump state from a first state to a second state such that the second state substantially matches the optimal state for the pump,
wherein the pump state comprises a pump speed and/or a pump run time.

2. The method according to claim 1, wherein the pump is a pool pump or a spa pump.

3. The method according to claim 1, wherein the pump is a fixed speed pump.

4. The method according to claim 1, wherein the pump is a variable speed pump.

5. The method according to claim 1, wherein the data on forecasted weather conditions is automatically received from a third part weather service.

6. The method according to claim 1, wherein the data on forecasted weather conditions comprises data on local weather conditions.

7. The method according to claim 1, wherein the data on forecasted weather conditions comprises data on at least one of wind, temperature, light, cloudiness, moisture, solar radiation, and pressure conditions.

8. The method according to claim 1, wherein the data on the at least one non-weather parameter further comprises data on one or more characteristics of a pool.

9. The method according to claim 1, wherein the data on the at least one non-weather parameter comprises data on a pool volume, a pool temperature, a water line pressure, a pump type, a pool filtration system, and input and output voltages supplied to the pump.

10. The method according to claim 1, wherein the second state comprises an increased, decreased or paused pump speed and/or an increased, decreased or paused pump run time.

11. The method according to claim 1, wherein the adjusting the state of the pump comprises energizing or de-energizing the pump at a predetermined time.

12. The method according to claim 1, further comprising enabling a utility provider to automatically adjust the pump state and/or shutting down the pump such that a load on a power grid is reduced.

13. The method according to claim 1, further comprising automatically adjusting the pump run time and/or automatically restarting the pump upon receiving an indication of a load shedding operation.

14. The method according to claim 1, further comprising shutting down the pump upon determining that the pump state exceeds a predetermined threshold value.

15. The method according to claim 14, further comprising raising an alarming indicator when the pump state exceeds the predetermined threshold value.

16. A pump controller comprising:
a regulator for adjusting a state of a pump from a first state to a second state; and
a processing unit in communication with the regulator, wherein the processing unit executes computer program code for:
receiving data from one or more sources on a plurality of pump control parameters, wherein the pump control parameters comprises:
(1) forecasted weather conditions; and
(2) at least one non-weather parameter;
generating an optimal state for the pump in dependence on the received data; and
at predetermined intervals, upon determination that a pump state deviates from the optimal state by a predetermined threshold value, instructing the regulator to adjust the pump state from the first state to the second state such that the second state substantially matches the optimal state for the pump,
wherein the pump state comprises a pump speed and/or a pump run time.

17. The pump controller according to claim 16, wherein the data on forecasted weather conditions is automatically received from a third part weather service.

18. The pump controller according to claim 16, wherein the data on the at least one non-weather parameter further comprises data on one or more characteristics of a pool or the pump.

19. The pump controller according to claim 16, further comprising one or more input/output units for providing data on the at least one non-weather parameter.

20. A non-transitory machine-readable storage medium comprising machine-implementable instructions for activities comprising:
receiving data from one or more sources on a plurality of pump control parameters, wherein the pump control parameters comprises:
(1) forecasted weather conditions; and
(2) at least one non-weather parameter;
generating an optimal state for the pump in dependence on the received data; and
at predetermined intervals, upon determination that a pump state deviates from the optimal state by a predetermined threshold value, adjusting a state of the pump from a first state to a second state such that the second state substantially matches the optimal state for the pump,
wherein the pump state comprises a pump speed and/or a pump run time.
